(19) United States
(12) Patent Application Publication
(10) Pub. No.: US 2026/0043738 A1
(43) Pub. Date: Feb. 12, 2026

(54) COMPUTATIONAL DUAL COMB BROADBAND SPECTROSCOPY METHOD AND SYSTEM

(71) Applicant: IPG PHOTONICS CORPORATION, Marlborough, MA (US)

(72) Inventors: Igor SAMARTSEV, Westborough, MA (US); Vadim LOZOVOY, Hudson, MA (US)

(73) Assignee: IPG PHOTONICS CORPORATION, Marlborough, MA (US)

(21) Appl. No.: 19/105,179

(22) PCT Filed: Aug. 23, 2023
(86) PCT No.: PCT/US2023/030887

§ 371 Date: Feb. 20, 2025

Related U.S. Application Data
(60) Provisional application No. 63/400,165, filed on Aug. 23, 2022.

(51) Int. Cl. G01N 21/35

(52) U.S. Cl. CPC G01N 21/35; G01N 2201/063

(57) ABSTRACT

The DCS includes a pair of optical frequency combs (FC) which generate respective outputs at different pulse repetition frequencies (PRF) in a monitoring regime mode characterized by free running FCs. The outputs are combined in a single output which is split between sample-investigating (SI) and reference channels with the latter including a cell with etalon material which has a known etalon spectrum at low pressure. The etalon spectrum contains one or more broadly spaced apart, high intensity narrow molecular lines. Upon interacting with one of the beams, the cell emits a cell signal detected by a photodetector. The cell signal is processed in a data processing unit operative to mathematically filter out a single molecular line of the etalon spectrum and correct the phase change in the filtered line. The corrected phase change is used to restore the desired spectrum of the cell signal and further the desired spectrum of the SI signal.

### BACKGROUND OF THE DISCLOSURE

### Field of the Disclosure

The disclosure relates to mid-IR dual comb spectroscopy (DCS). In particular, the disclosure relates to a system and method for providing the desired spectrum of a sample-investigating (SI) signal detected in one channel of the DCS by continuously monitoring a phase change in a single molecular line of the etalon material located in the other channel of the DCS.

### Prior Art

Spectroscopy uses light to determine physical, chemical or structural properties of materials. Absorption spectroscopy, which is the subject matter of this application, is based on identifying which wavelengths of light a substance absorbs by measuring the photons it allows to pass through. Mid-infrared spectroscopy (mid-IR spectroscopy) is concerned with a spectral region extending from about 2 μm to at least 14 μm, and relies on light absorption. The mid-IR spectral region is critical in the identification and analysis of a diverse array of materials. The dominant spectroscopic approach in the mid-IR is Fourier-transform (FR) IR spectroscopy.

Referring to FIGS. 1 and 2, one of the techniques used in the FR IR spectroscopy is dual-comb spectroscopy (DCS). Generally the DCS includes two frequency combs (FC_{1,2}) which each are a coherent broadband light source formed by evenly spaced optical frequencies. The outputs of respective combs are combined, and the combined output is passed through the sample to be analyzed, after which it is detected by a photo-detector (PD). Referring to FIG. 1, the result, in the time domain, is a repeated series of interferometric signals, with a steadily increasing time difference based on the difference in PRF between combs FC₁ and FC₂. The distinct peak on the interferogram corresponds to the point of time when two pulses from respective combs overlap one another at the PD. FIG. 2 illustrates the result of passing the combined pulse train through the sample in the frequency domain. Here two combs with slightly different mode spacing enable heterodyne detection, as mixing the two optical FCs converts them to a single RF comb.

With all well-known advantages of the MID-IR DCS, to accurately and precisely measure the properties, the constant PRF of each comb has a tremendous impact on the error and uncertainty of the ascertained line properties assuming all else is equal. The DCS accuracy is thus predicated on keeping the PRF difference between FCs within the desired range regardless of numerous environmental factors such as vibration, temperature fluctuation, etc., which are unavoidable outside the laboratory.

Traditional DCS uses phase locking each FCs against an etalon laser, such as single frequency single mode (SFSM) CW laser. Typically, traditional DCS requires a complex electro-mechanical set-up including multiple servo-locks in combination with feedback loops which are needed to accomplish the phase lock.

FIG. 3 diagrammatically illustrates one of known schematics of computational MIR DSC disclosed in fully incorporated herein US 2017/0307443 (US '443) which dispenses with the phase-locking electro-mechanical set-up of the traditional DCS. In particular, US '443 teaches a method for correcting envelope frequency offset (CEFO) jitter. The schematic includes at least two FC₁ and FC₂ combs outputting respective pulsed beams at slightly different PRFs. The combs are spatially combined in combiner C₁ and C₂ located in respective working and reference channels which include sample S to be analyzed and reference material R respectively. The reference R has at least one known spectral line. Referring specifically to the reference channel, the output from the cell with reference material R is detected by a reference photodetector (PD) which outputs the heterodyned signal. The interferogram of the latter is recorded in a data processing unit DPU which cuts it into sections S₁-Sₙ, wherein n=2, 3 . . . n-1.

Upon transforming each section S into frequency domain, the first section S1 is used as baseline and all other sections each are compared to it. The comparison between two sections indicates the time delay therebetween and frequency lags for each section. The calculated time and frequency lags in the reference channel allow the DPU to periodically correct the obtained frequency spectrum caused by CEFO jitters in the working channel.

In the above-discussed reference, what appears to be of secondary consideration is how an instantaneous PRF difference between the combs changes. Based on the teaching of the reference, even when the PRF difference appears to be of interest, it is determined based on comparison between sections, but not within any given section. However, if the PRF change over the duration of a single section is ignored, the measured data can be compromised.

Multiple correction algorithms for controlling and maintaining the coherence between the combs are written and used with different degrees of success. Therefore, since the computational DCS is an extremely promising technique, a relatively simple correction algorithm distinguished by its ability to continuously monitor phase/frequency fluctuation, is needed.

### SUMMARY OF THE DISCLOSURE

The disclosed computational MIR DCS meets this need by utilizing a molecular reference - a cell with etalon material, typically gas with to calibrate time-domain data in signal processing.

The disclosed DCS operates in two regimes. In one of the regimes, a PRF difference between two outputs of respective FC if the PRF is periodically controlled. The control involves the adjustment of the resonator cavity of at least one of the FCs.

The other regime provides for continuously monitoring the PRF difference while the FCs are free running. The disclosed configuration associated with the monitoring regime includes combining two outputs from respective FCs into a single combined DCS output which is then split into two beams. The beams are further guided along respective sample investigating (SI) and reference channels. The beam propagating along the reference channel shines on the cell with etalon material which has the known spectrum including one or more broadly spaced, high intensity narrow molecular lines. The linewidth of each molecular line is the same as or smaller than the resolution limit for a spectrometer used in the disclosed MIR DCS. The other beam interacts with the sample to be measured which results in the emission of a sample investigating (SI) signal.

The cell signal emitted from the cell is detected by a PD and has a narrow optical spectrum which is filtered out of the spectrum of the combined DCS output and includes the spectrum of the etalon material. The PD outputs a heterodyned cell signal whose interferogram is first recorded and then divided into a plurality of frames in the time domain. Each of the frames in the time domain is further mathematically processed to be transferred to a corresponding spectrum of the detected cell signal in the RF frequency domain, which is smeared due to the instabilities of the PRF difference. The ultimate goal of the disclosed system and method is to restore the detected spectrum to the desired spectrum for each frame of the recorded interferogram in the reference channel, and then use the obtained data in the reference channel to restore the desired spectrum of a corresponding frame in the SI channel which is indicative of correct measurements.

The processing of each frame begins with mathematically transferring the interferogram of each frame to the RF frequency domain obtaining thus the corresponding spectrum. In accordance with the inventive concept, one of the molecular lines of the etalon material's spectrum is further mathematically filtered out of the RF spectrum. For this filtered single molecular line, a computer executable program determines a change of phase. Once the phase change is determined, it is used to correct the interferogram of the frame under investigation which is further transferred to the frequency domain resulting in obtaining the desired spectrum. Eventually, the corrected phase change is used to restore the desired spectrum of the corresponding frame in the SI channel.

In accordance with one inventive feature, the phase change within the filtered molecular line is determined by utilizing one of numerous and well known to one of ordinary skill in the computer science standard programs. As the phase change being calculated, the data obtained as a result of this calculation is used for creating the absorption spectrum of the frame under investigation. The constructed absorption spectrum is further matched with a pre-stored absorption spectrum which, for example, is obtained at a tune-up stage of the DCS with the FCs being phase locked or mathematically determined. Once the result of comparison is satisfactory, the calculated phase change is used for restoring the desired RF spectrum of the frame under investigation in the reference channel and further for the same reason in a corresponding frame of the SI signal.

In accordance with another feature, the reference value is the phase change of the detected cell signal obtained with the same DCS system but operating with the mode-locked FCs. Upon matching the measured with the reference value, the deviation of the measured phase change from the reference phase change is determined and corrected. The corrected phase change, after a sequence of Fourier transform steps, leads to the correction of the detected spectrum which is thus restored to the desired spectrum of the frame under investigation in the reference channel. The corrected phase change is further used to obtain the desired spectrum for a corresponding frame in the SI channel assuring thus the correctness of spectroscopic measurements.

The above and other features of the inventive DCS technique and setup, which are all structurally and functionally interrelated with one another, are disclosed in greater detail in the following specific description of the present application.

### BRIEF DESCRIPTION OF THE DRAWINGS

Aiding the specific description of the inventive concept are the following drawings, in which:

FIG. 1 illustrates the DCS output in the time domain;

FIG. 2 illustrates the DCS output in the frequency domain;

FIG. 3 is an exemplary schematic of computational DCS of the known prior art using a molecular reference;

FIG. 4 is a highly diagrammatic setup of the inventive DCS;

FIG. 5 is a flow chart of the inventive computational signal processing algorithm;

FIG. 6A-6H are respective computer shots illustrating the steps of algorithm of FIG. 5;

FIG. 7 illustrates the concept of windows of beating.

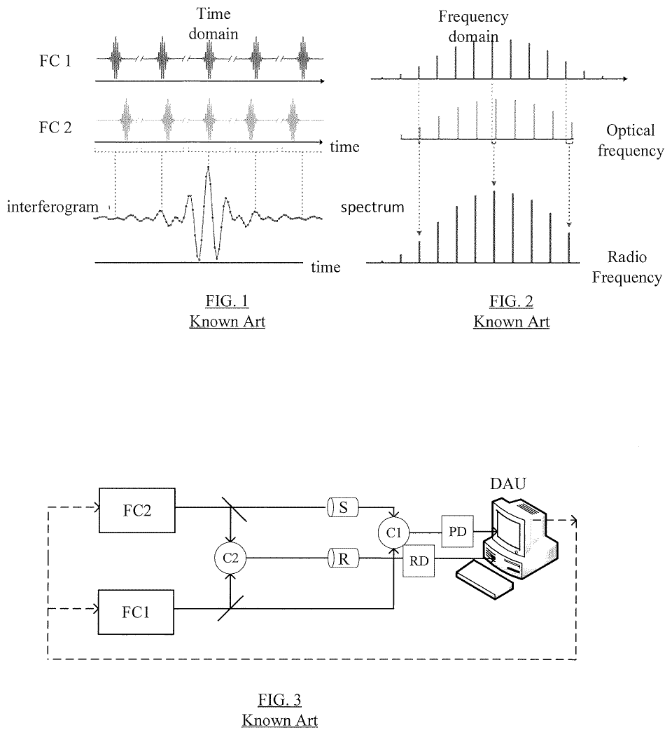

### SPECIFIC DESCRIPTION

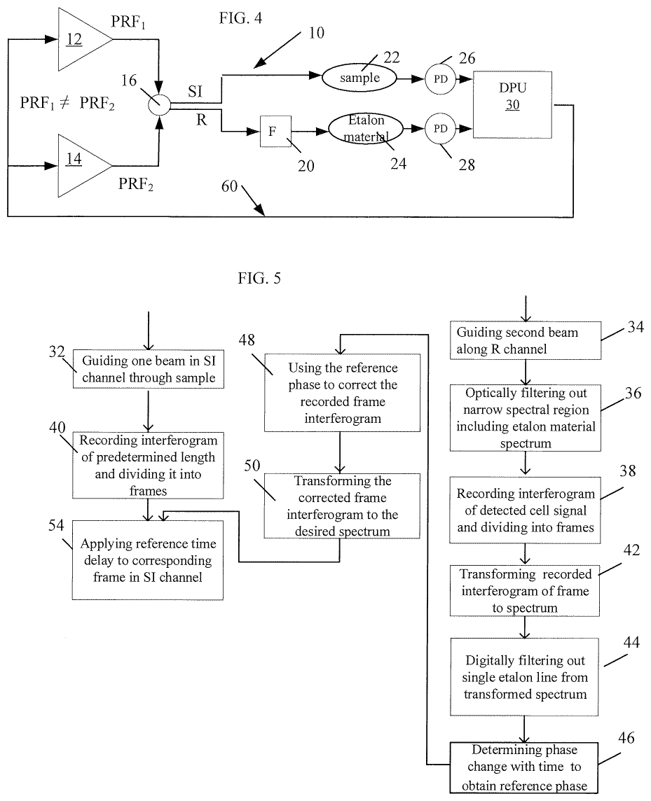

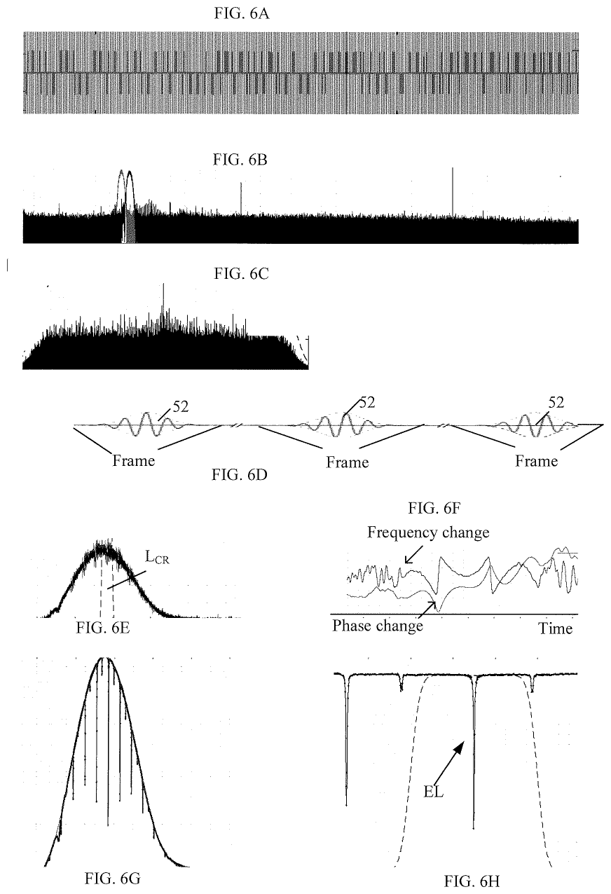

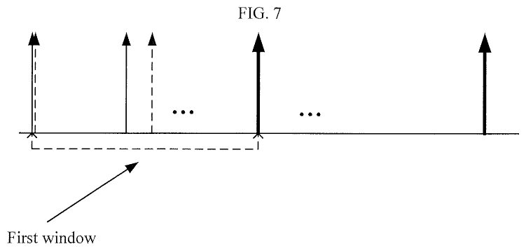

The DCS system implementing the inventive method operates in a control regime wherein the PRF difference between two FCs is periodically adjusted to be within the desired range, and a monitoring regime wherein the PRF difference is continuously monitored while the FCs are free running. The inventive system is distinguished from the known prior art by a combination of structural and signal processing components. The structural component includes a cell with etalon material reemitting a cell signal with the known spectrum as a result of the interaction with a portion of the DCS output. The signal processing component relates to a computer-executable technique for continuously monitoring the phase change in the mathematically filtered single line of the known spectrum to maintain the desired spectrum of a sample-investigating signal which is emitted by the sample interacting with the other portion of the DCS output FIG. 4 in combination with FIGS. 5 and 6A-6H illustrate the inventive method and DSC optical schematic 10 including two or more solid state FCs 12 and 14, respectively, at slightly different PRF₁ and PRF₂. For example, PRF₁ of CF 12 may be selected from 80 to 100 MHz in the radio frequency (RF) domain (12 ns in time domain), whereas the PRF difference between outputs of respective FCs is selected, for example, from a 50-100 Hz range. The FCs 12 and 14 are similarly configured to output respective femtosecond (fs) pulse trains with substantially uniform pulses. However, even if the amplitudes of respective pulses of each pair vary relative to one another of up to 10%, the inventive concept is not compromised.

The spectra of respective comb outputs of FCs 12, 14 are identical to one another, and each spectrum covers a MIR region between 2 and at least 14 μm. The MID-IR combs may be selected from near IR sources, such as fiber lasers, or directly from MID-IR semiconductor lasers, optical parametric oscillators, micro-resonators. The lasers tested in the experimental DCS system include selenium chrome laser diodes.

The combiner 16 of FIG. 4 optically combines the outputs of respective FCs 12, 14 in a combined output which is further split into two beams guided along respective sample-investigating and reference channels. The combiner 16 may include a single optical bulk component, such as prism which combines and then splits the combined FC output into the two time-correlated beams. Alternatively, two different optical components can be used instead of the single prism.

Referring to FIG. 5 in addition to FIG. 4, the split beams are guided further along respective channels with a first beam in the signal investigating channel shinning on sample 22 to be tested in step 32 and the second beam being transmitted through a cell with etalon material 24 in step 34 of FIG. 5. Before being incident on the cell with etalon material 24, the second beam is guided through an optical filter F of FIG. 4, such as a diffraction grating 20 which cuts out a narrow spectral region between 1 and 5 (optical) GHz as indicated by step 34 of FIG. 5. The relative position of the filter F and the cell can be reversed so that the second beam is initially guided through etalon material 24 and then optically filtered. In either configuration, the optically filtered spectrum of the propagating beam includes the known spectrum of the etalon material.

The known spectrum of etalon material at low pressure, such as nitride monoxide (NO), has the etalon spectrum with one or few broadly spaced apart high intensity, narrow molecular lines. Each line has a high intensity and narrow spectral width close to the resolution limit of the utilized spectrometer. While a single molecular line can be optically cut out by filter 20, it would entail a structural complexity considering that the spectral width of the line preferably is about 100 MHZ. Yet this option is not excluded from the disclosed subject matter. The spectral region cut out by optical filter 20 in step 36 of FIG. 5 is substantially bell-shaped (not shown, but well known to artisans) so that the position of each molecular line with respect to the central region of the bell-shaped region is known.

DCS strength stems from the massively parallel heterodyne down-conversion procedure that enables direct mapping of the information encoded in the optical domain to the RF domain, where data processing unit (DPU) 30 with analog-to-digital converters is used to process and acquire the signals. This requires spatial overlap of the comb outputs from two matched FCs which causes optical beating frequencies spread over the PD bandwidth. To realize this concept, it is imperative that combs 12, 14 preserve the mutual coherence since any significant drift or fluctuation of the PRF degrades the system's performance over long time-scales, as here. However, since combs 12, 14 are free running in the monitoring regime, as further explained, the PRF difference experiences instabilities which are a huge detriment eventually resulting in the loss of information. The disclosed DCS system and technique cure this as explained below.

Returning to FIGS. 4 and 5 in light of FIG. 6A-6H, the sample-investigating (SI) and cell signals, which are output by respective sample 22 and etalon material 24 as a result of interaction with respective beams, are detected by PDs 26, 28. Both signals have their respective interferograms recorded in a time-synchronizing manner in respective steps 40 and 38 of FIG. 5 with one of these interferograms being shown in FIG. 6A. The recorded interferograms are stored in the memory of DPU 30 for further signal processing. FIG. 6B illustrates the spectrum of a portion of the interferogram of FIG. 6A which has not yet been processed.

The signal processing, which is particularly important for the monitoring regime of inventive DCS 10, begins with each interferogram to be digitally divided into a plurality of short uniform interferograms referred to as frames. The time duration of each frame in both channels can be, for example, 10 milliseconds. The interferogram corresponding to the single frame of the detected cell signal is shown in FIG. 6C.

FIG. 6D graphically explains the term frame. As the pulses of respective FCs 12, 14 of FIG. 4 are output at different PRFs, at a certain period of time two pulses of respective combs simultaneously impinge on the input of PD 28, for example. In the recorded interferogram, this interference is detected as a peak 52 the three of which are shown in succession. Each peak 52 is considered to be the frame center. The digital sectioning of the interferograms into individual frames in respective SI and reference channels is time-synchronized meaning that for each frame in the reference channel a time-correlated frame in the SI channel exists. The number of frames may vary from tens to hundreds subject to the compromise between the computer memory and volume of mathematical transformations. FIG. 6A, for instance, includes 400 frames.

Referring to FIG. 6E corresponding to step 42 of FIG. 5, the single frame of the detected cell signal is Fourier transformed (or any other suitable transform) to the RF frequency domain-the spectrum of the detected etalon cell signal of FIG. 6E. To be clear, the detected spectrum as shown is not yet mathematically corrected which explains why this spectrum is smeared by jitters with not a single molecular line being clearly identified. The reason for such a spectrum is the unstable PRF difference between outputs of respective combs 12, 14 of FIG. 4.

However, since the position of the molecular lines relative the center of the optical filter 20 of FIG. 4 is known, it is easy to mathematically cut out any single line of the etalon spectrum. Preferably, but not necessarily, the filtered line L_{CR} is located within the central region of the spectrum of FIG. 6E. Transferring the spectrum of the single filtered line to the time domain allows determining the phase change based on the reference value. Once restored to the preset or digitally determined reference value, the measured phase change, after a few transformations as explained later, is applied first to the spectrum of FIG. 6E of the detected etalon signal as shown by step 50 of FIG. 5 and further to the spectrum of the SI signal in step 54 of FIG. 5. As a result, the spectra of respective cell and SI signals for corresponding frames are corrected to the desired spectrum as shown in FIG. 6G and explained below. The desired spectrum of the SI signal assures the correctness of future spectroscopic measurements of the sample.

Referring to FIG. 6F, the red line represents the already corrected phase change in the filtered line Lcr of FIG. 6E which corresponds to step 46 of FIG. 5. One of the possibilities to accomplish this task is to compute an absorption spectrum of FIG. 6H while determining the phase change with the known to one of ordinary skill programs. Once the phase change is determined, a computer executable program uses the determined phase change to create the absorption spectrum for the entire frame of FIG. 6C. Thereafter, the created spectrum and a reference spectrum, which is used as a reference value and stored in the computer memory, are mathematically matched to make sure that the determined phase change is acceptable. The reference spectrum can be either mathematically determined or obtained with FCs 12, 14 being phase locked which usually occurs during a tune-up stage before the device is shipped out to the customer.

The filtered molecular line Lcr of FIG. 6E is so narrow that the reference phase change and time delay functions are similar. The determined phase change is then used for correcting the interferogram of FIG. 6C, as indicated by step 48 of FIG. 5. The latter, in turn, is again transferred to the frequency domain and used to restore the desired spectrum of the current frame as shown in FIG. 6G. The desired spectrum, if compared to the detected spectrum of FIG. 6E, is characterized by well-defined lines, including the central line Lcr, and the smooth envelope.

Alternatively, the phase change of filtered line Lcr of FIG. 6E can be corrected by comparing the measured phase change to a pre-stored reference phase change, which is considered to be a reference value obtained in the phase-locked DCS. Typically, devices are tuned up before being shipped to a customer and certain characteristics, such as the phase change with the phase-locked FCs, can be stored in the computer memory. Having restored the measured phase change to the reference change, which is considered to the reference value, the desired spectrum of FIG. 6G is obtained in a manner identical to the above-disclosed sequence.

Returning to FIG. 6F, the blue line represents the frequency change which is derivative of the phase change in the selected filtered line Lcr. The importance of the computed frequency change should be viewed in light of the PRF difference between the outputs of respective combs 12, 14 of FIG. 4. If this determined frequency changes beyond a preset range within the filtered line, which may be empirically or digitally determined is a sure indication that the PRF difference between the comb outputs is not anymore within the predetermined range associated with the free running FCs 12, 14. And if the PRF difference of the FCs is not within the predetermined range, the DPU 30 will not be able to restore the desired spectrum of FIG. 6G. The corrupted frame may be ignored and thrown away while waiting for the next “good” frame. However, if the problem with the phase change correction persists, the monitoring regime is interrupted and the system is switched in the control regime with a control signal being generated by DPU 30 having a feedback loop 60 as show in FIG. 4. The control signal is coupled into the actuator, such as a piezo or step motor of one or both FC combs 12, 14, which adjusts the length of the resonant cavity. Once the PRF difference returns within the preset range stored in the memory of the computer, the DCS 10 returns to its monitoring regime in which FCs 12 and 14 of FIG. 4 are free running.

After obtaining and storing a plurality of frames with the desired spectrum, it is necessary that the noise be reduced increasing thus a signal-to-noise ratio (SNR). The basic idea of averaging for spectral noise reduction is the same as arithmetic averaging to find a mean value. For example, it is possible to provide averaging in the time-domain by processing the interferograms of respective stored frames. The reduction of noise obviously depends on the total number of frames. The more frames, the better the SNR. But interferograms contain a lot of data threatening to overload the computer's memory. On the other hand, averaging the spectra of respective frames requires extensive computation which increases the processing time. As the frames constituting, for example the interferogram of FIG. 6A, are stored, the compromise can be found by processing, for example, 100 frames based on the respective interferogram. The rest of the frames may dealt with based on respective spectra.

Having accomplished the above disclosed signal processing, the reference phase or rather time delay change in each frame of the etalon material cell signal is applied to the corresponding frame of the sample-investigating material. Having restored the entire spectra of the sample signal to the desired spectrum, using the above-disclosed technique, assures the correctness of the spectroscopic measurements.

FIG. 7 illustrates still another feature of the invention, the disclosed computational technique allows preventing the uncertainty caused by conversion between RF and optical frequencies. When the outputs of respective combs 12, 14 are mathematically transformed, initially a pair of solid and dash lines which correspond to respective outputs, stand practically together and hardly can be distinguished on a spectro analyzer. However, as the combs keep operating at respective different PRFs, the dash line representing, for example, the output of FC 14 continues to distance itself from the paired solid line of FC 12. As the distance between these two lines increases, the dash line of comb 14 eventually reaches the next solid line and overlaps it, after which this sequence continue with the continuously increasing distance between the dash line and next solid line. The interval during which the dash line covers the distance between the first and next solid lines is referred to as the first window of beating.

Accordingly, the optical PRFs of respective FCs 12, 14 are selected so that the entire optical spectrum of the DCS's output is within a first window of beating. Operating in this first window rather than in any subsequent window includes simple and precise determination of the correspondence between RF and optical frequencies. Otherwise, subsequent windows require additional electronic equipment and complicated computational techniques to find the correspondence between RF and optical frequencies.

The features disclosed herein in accordance with the present invention, are not limited in their application to the details of construction and the arrangement of components set forth in the following description or illustrated in the accompanying drawings. These features are capable of assuming other embodiments and of being practiced or of being carried out in various ways. Examples of specific implementations are provided herein for illustrative purposes only and are not intended to be limiting. In particular, acts, components, elements, and features discussed in connection with the optical schematic and signal processing system are not intended to be excluded from a similar role in any other embodiments.

Also, the phraseology and terminology used herein is for the purpose of description and should not be regarded as limiting. References in the singular or plural form are not intended to limit the presently disclosed systems or methods, their components, acts, or elements. In addition, in the event of inconsistent usages of terms between this document and documents incorporated herein by reference, the term usage in the incorporated reference is supplementary to that of this document; for irreconcilable inconsistencies, the term usage in this document controls.

Having thus described several features of at least one example, one of ordinary skill in the art readily appreciates that various alterations, modifications, and improvements will readily occur to those skilled in the art. For instance, examples disclosed herein are applicable in other contexts. Such alterations, modifications, and improvements are part of this disclosure. Accordingly, the foregoing description and drawings are by way of example only.

1. A computational mid-IR dual comb spectroscopy (DCS) system operating in a control regime and a monitoring regime, the DCS system operating in the monitoring regime comprising:
free running frequency combs (FCs) generating respective outputs at pulse repetition frequencies (PRF) which are offset relative to one another within a preset PRF range, wherein the outputs are optically combined into a system output which is split into first and second beams propagating along respective sample investigating (SI) and reference optical channels;
a cell with etalon material located in the reference channel and interacting with the first beam so as to output a cell signal including an etalon spectrum of the etalon material;
a first photodetector (PD) capturing the cell signal and outputting a heterodyned cell signal with an interferogram thereof being recorded; and
a data processing unit (DPU) processing the heterodyned cell signal by:
slicing the interferogram into a sequence of uniform frames,
mathematically transforming each frame in the time domain to a corresponding etalon cell spectrum in the frequency domain,
filtering out a single molecular line from each etalon cell spectrum,
determining a phase change of each of the filtered molecular lines, and
matching the determined phase change of each filtered molecular line with a reference value, thereby, if needed, correcting the determined phase change, and
using the corrected determined phase change to restore each of the desired etalon cell spectra.

2. The mid-IR DCS system of claim 1 further comprising a cell with a sample to be tested which outputs a sample investigating (SI) signal upon transmitting the second beam in the SI channel, and a second PD receiving the SI signal and outputting another heterodyned signal whose interferogram is recorded and sliced into a plurality of frames which are time-correlated with respective frames of the interferogram of the heterodyned cell signal.

3. The mid-IR DCS system of claim 2, the DPU, for each frame of the heterodyned signal in the reference channel, is operative to create an absorption spectrum based on the determined phase change, and compare the created absorption spectrum with a pre-stored reference absorption spectrum, the pre-stored absorption spectrum being the reference value.

4. The mid-IR DCS system of claim 2, wherein the reference value is a phase change in the filtered line obtained with the FCs which are phase locked against one another.

5. The mid-IR DCS system of claim 2, wherein, for each frame, the DPU is operative to use the corrected phase change to correct the interferogram of the heterodyned cell signal, the DPU being further operative to transform the corrected interferogram of each frame to the corresponding desired cell spectrum of the cell signal.

6. The mid-IR DCS system of claim 5, wherein the corrected phase change in the filtered molecular line in each of the individual frames of the interferogram of the cell signal is applied to a corresponding frame of the interferogram of the sample signal.

7. The mid-IR DCS system of claim 1 further comprising an optical filter in the reference channel located before or after the cell with etalon material and optically filtering out a narrow spectral region of the spectrum of the one beam, wherein the filtered spectral region is includes the etalon cell spectrum of the etalon material.

8. The mid-IR DCS system of claim 2, wherein the PRFs of respective FCs are selected so that the optical spectrum of the beams is included in a first window of beating.

9. The mid-IR DCS system of claim 7, wherein the optically filtered spectral region has a bell shape having a central region occupied by the selected single molecular line.

10. The mid-IR DCS system of claim 2, wherein the frames each correspond to simultaneous incidence of a pair of pulses of respective outputs of the FCs on the first and second PD.

11. The mid-IR DCS system of claim 1, wherein the DPU is operative to derive a frequency change from the corrected phase change in the filtered molecular line for controlling the preset range of the PRF difference between the outputs of respective FCs.

12. The mid-IR DCS system of claim 11, wherein the FCs are solid state femtosecond lasers generating respective outputs with the uniform spectrum in a 2 to 14 μm spectral range.

13. A method for operating a mid-IR DCS system which functions in a control regime for periodically controlling a PRF difference between two FCs of the DCS, and a monitoring regime for continuously monitoring the PRF difference with free running FCs, wherein the method of operating the DCS in the monitoring regime comprising:
combining the outputs of respective FCs into a combined output and splitting the combined output into two beams with a uniform spectrum;
guiding the split beams along respective sample-investigating and reference channels through a sample to be tested and a cell with etalon material, thereby generating respective sample investigating (SI) and cell signals, the cell signal containing a spectrum of the etalon material;
detecting SI and cell signals by respective PDs which output respective heterodyned SI and cell signals whose interferograms are recorded;
slicing the interferograms of respective heterodynes SI and cell signals each into a sequence of uniform frames and processing each frame of the heterodyned cell signal by:
mathematically transforming the frame to a corresponding spectrum which includes one or more molecular lines of the etalon material spectrum;
filtering out a single molecular line from the corresponding spectrum;
determining a phase change in the filtered single molecular line based on a reference value, thereby restoring the spectrum of each frame to the desired spectrum.

14. The method of claim 13, wherein the frames of the interferogram of the heterodyned cell signal are time-correlated with corresponding frames of the heterodyned SI signal.

15. The method of claim 14, wherein the step of determining the phase change in the filtered single molecular line of each frame includes computing an absorption spectrum of the cell signal until the computed absorption spectrum matches a predetermined absorption spectrum which corresponds to the reference value.

16. The method of claim 14 comprising matching the determined phase change with a stored phase change, wherein the stored phase change is the reference value.

17. The method of claim 14 further comprising using the corrected phase change of the cell signal in the filtered molecular line for each frame to correct the interferogram, and converting the corrected interferogram to the desired corresponding spectrum of the cell signal.

18. The method of claim 17 further comprising averaging the frames of cell signal by summing up a plurality of the corrected interferograms and a plurality of desired spectra of the cell signal.

19. The method of claim 14, further comprising optically filtering the beam in the reference channel to cut out a spectral region which corresponds to the etalon material spectrum, wherein the single molecular line is located within a central region of the spectral region.

20. The method of claim 14 further comprising interrupting the monitoring regime, thereby switching the DCS to the control regime to adjust a resonant cavity of at least one of the FCs if the PRF difference between respective FCs shifts outside a desired range.

21. A computational mid-IR dual comb spectroscopy (DCS) system operating in a control regime and a monitoring regime, the DCS system operating in the monitoring regime comprising:
free running frequency combs (FCs) generating respective outputs at pulse repetition frequencies (PRF) which are offset relative to one another, wherein the outputs are optically combined into a system output which is split into first and second beams propagating along respective sample investigating (SI) and reference optical channels;
a cell with etalon material located in the reference channel and interacting with the first beam so as to output a cell signal including an etalon cell spectrum of the etalon material; and
a data processing unit (DPU) receiving the cell signal and executing a program for
filtering a single molecular line of the etalon cell spectrum,
determining a phase change in the filtered molecular line, and
comparing the determined phase change to a reference value and, if needed, correcting the determined phase change which is used to restore a desired etalon spectrum of the cell signal.

22. The mid-IR DCS system of claim 21 further comprising a cell with a sample to be tested which outputs a sample investigating (SI) signal upon transmitting the second beam through the SI channel, and a second PD receiving the SI signal, wherein the corrected phase change in the filtered molecular line of the cell signal is used to restore the desired spectrum of the SI signal.

23. The mid-IR DCS system of claim 21, wherein the reference value includes a predetermined absorption spectrum, the DPU being operative to create a measured absorption spectrum based on the determined phase change in the filtered molecular line of the etalon spectrum.

24. The mid-IR DCS system of claim 21, wherein the reference value is a phase change in the filtered line obtained with the FCs which are phase locked against one another.

25. The mid-IR DCS system of claim 21, wherein in the control regime, the DPU executes a program for generating a signal which is coupled into one of or both actuators of respective FCs which are operative to alter a length of respective resonant cavities of the FCs if the PRF difference between the outputs of respective FCs is detected to be outside a predetermined range.
